(19) United States
(12) Patent Application Publication
(10) Pub. No.: US 2006/0095781 A1
(43) Pub. Date: May 4, 2006

(54) Method for mapping a shared resource in a network

(75) Inventor: Jun Liu, Shanghai (CN)

Correspondence Address: OSTROLENK FABER GERB & SOFFEN, 1180 AVENUE OF THE AMERICAS, NEW YORK, NY, 100368403, US

(73) Assignee: Universal Scientific Industrial Co., Ltd.

(21) Appl. No.: 11/034,184

(22) Filed: Jan. 12, 2005

(30) Foreign Application Priority Data
Nov. 4, 2004 (TW) 93133618

(51) Int. Cl. H04L 9/00

(52) U.S. Cl. 713/183

(57) ABSTRACT

A method for mapping a shared resource of a server by a client in a network includes the steps of enabling the client to broadcast automatically a user identity thereof through the network, enabling the client to receive an IP address and shared resource allocation information of the server transmitted through the network, enabling the client to transmit a user password thereof to the server through the network for verification, and enabling the client to map the shared resource of the server with the use of the IP address and the shared resource allocation information of the server upon successful verification of the user password by the server.

### BACKGROUND OF THE INVENTION

1. Field of the Invention

The invention relates to a method for mapping a shared resource of a server by a client in a network, more particularly to a method for mapping a shared resource of a server by a client in a network without user intervention.

2. Description of the Related Art

A conventional method for mapping a network drive of a server by a client in a network is performed manually by a user.

The aforesaid conventional method is disadvantageous in that the internet protocol (IP) address of the server has to be configured in the client, and that the user has to input a user account and a user password every time the client is booted up.

### SUMMARY OF THE INVENTION

Therefore, the object of the present invention is to provide a method for mapping a shared resource of a server by a client in a network without user intervention so as to overcome the aforesaid drawbacks of the prior art.

According to a first aspect of the present invention, a method for mapping a shared resource of a server by a client in a network comprises the steps of:

(A) enabling the client to broadcast automatically a user identity thereof through the network;

(B) enabling the client to receive an internet protocol (IP) address and shared resource allocation information of the server transmitted through the network;

(C) in response to the IP address and the shared resource allocation information of the server received in step (B), enabling the client to transmit a user password thereof to the server through the network for verification; and

(D) enabling the client to map the shared resource of the server with the use of the IP address and the shared resource allocation information of the server upon successful verification of the user password by the server.

According to a second aspect of the present invention, a method for mapping a shared resource of a server by a client in a network comprises the steps of:

(A) enabling the server to detect automatically a user identity of the client broadcasted through the network;

(B) enabling the server to transmit an IP address and shared resource allocation information of the server through the network when the user identity of the client detected in step (A) corresponds to one of a plurality of predetermined user accounts configured in the server; and

(C) enabling the server to receive and verify a user password of the client transmitted through the network after step (B);

whereby the client is able to map the shared resource of the server with the use of the IP address and the shared resource allocation information of the server upon successful verification of the user password by the server.

According to a third aspect of the present invention, a method for mapping a shared resource of a server by a client in a network comprises the steps of:

(A) enabling the server to broadcast periodically and automatically user accounts configured therein through the network;

(B) enabling the server to receive and verify a user password of the client transmitted through the network; and

(C) enabling the server to transmit an IP address and shared resource allocation information of the server through the network upon successful verification of the password;

whereby the client is able to map the shared resource of the server with the use of the IP address and the shared resource allocation information of the server.

According to a fourth aspect of the present invention, a method for mapping a shared resource of a server by a client in a network comprises the steps of:

(A) enabling the client to detect automatically user accounts configured in the server and broadcasted through the network;

(B) enabling the client to transmit a user password thereof to the server through the network for verification when a user identity of the client corresponds to one of the user accounts of the server detected in step (A);

(C) enabling the client to receive an IP address and shared resource allocation information of the server through the network after step (B); and

(D) in response to the IP address and the shared resource allocation information of the server received in step (C), enabling the client to map the shared resource of the server with the use of the IP address and the shared resource allocation information of the server.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a system for implementing the first preferred embodiment of the method for mapping a shared resource of a server by a client in a network according to the present invention;

FIG. 2 is a flowchart to illustrate steps performed by the client in the system of FIG. 1;

FIG. 3 is a flowchart to illustrate steps performed by the server in the system of FIG. 1;

FIG. 4 is a schematic block diagram of a system for implementing the second preferred embodiment of the method for mapping a shared resource of a server by a client in a network according to the present invention;

FIG. 5 is a flowchart to illustrate steps performed by the server in the system of FIG. 4; and

FIG. 6 is a flowchart to illustrate steps performed by the client in the system of FIG. 4.

### DETAILED DESCRIPTION OF THE PREFERRED EMBODIMENTS

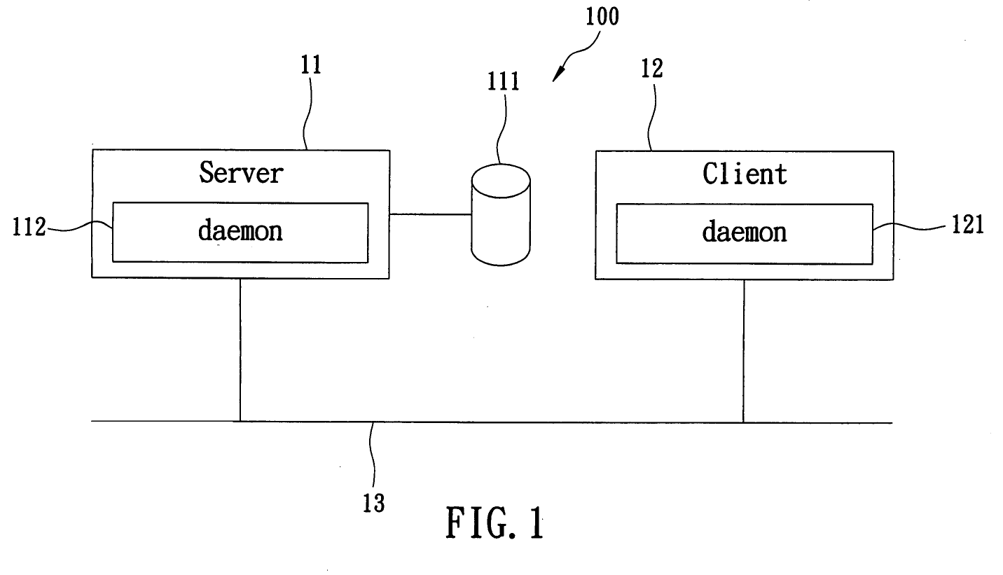

FIG. 1 illustrates a system 100 for implementing the first preferred embodiment of the method for mapping a shared resource 111 of a server 11 by a client 12 in a network 13 as initiated by the client 12.

The server 11 is configured with an internet protocol (IP) address and a plurality of predetermined user accounts.

The client 12 is configured with a user identity and a user password. In this embodiment, the client 12 is a personal computer. In an alternative embodiment, the client 12 is a notebook computer.

The network 13 is a local area network. In this embodiment, the client 12 is connected to the local area network 13 through a cable. In an alternative embodiment, the client 12 is connected to the local area network 13 wirelessly.

The shared resource 111 of the server 11 is a network drive that is to be mapped as a local drive by the client 12, in a manner that will be described hereinafter.

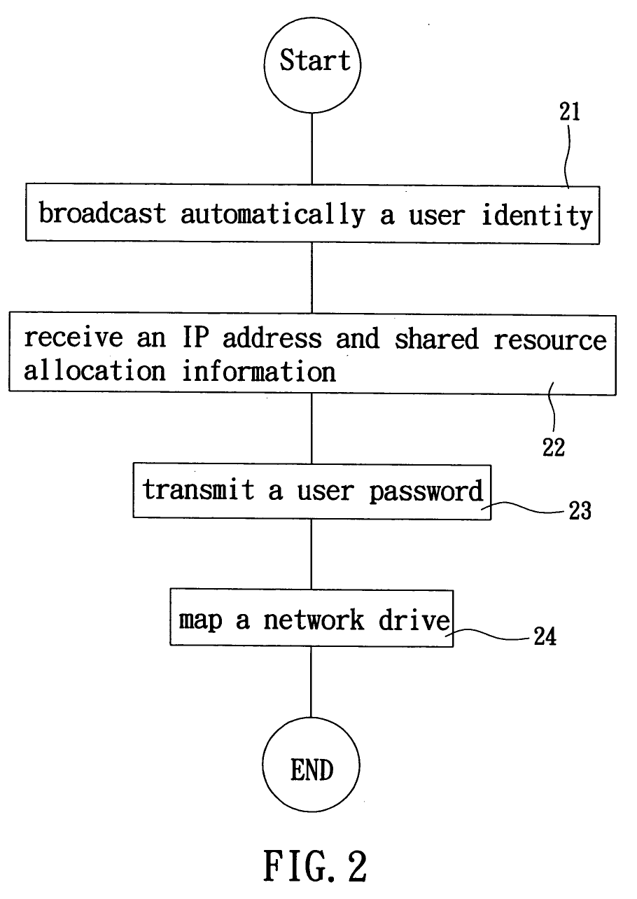

In this embodiment, the client 12 of the system 100 according to this invention is installed with proprietary daemon software 121 so as to enable it to interact with the server 11 for executing steps associated with the method of the first preferred embodiment. The steps performed by the client 12, as illustrated in FIG. 2, are as follows:

In step 21, upon booting up, the client 12 broadcasts automatically the user identity thereof through the local area network 13. Thereafter, in step 22, the client 12 receives the IP address and shared resource allocation information of the server 11 transmitted through the local area network 13.

In step 23, in response to the IP address and the shared resource allocation information of the server 11 received in step 22, the client 12 transmits the user password thereof to the server 11 through the local area network 13 for verification.

In step 24, the client 12 maps the network drive 111 of the server 11 with the use of the IP address and the shared resource allocation information of the server 11 upon successful verification of the user password by the server 11.

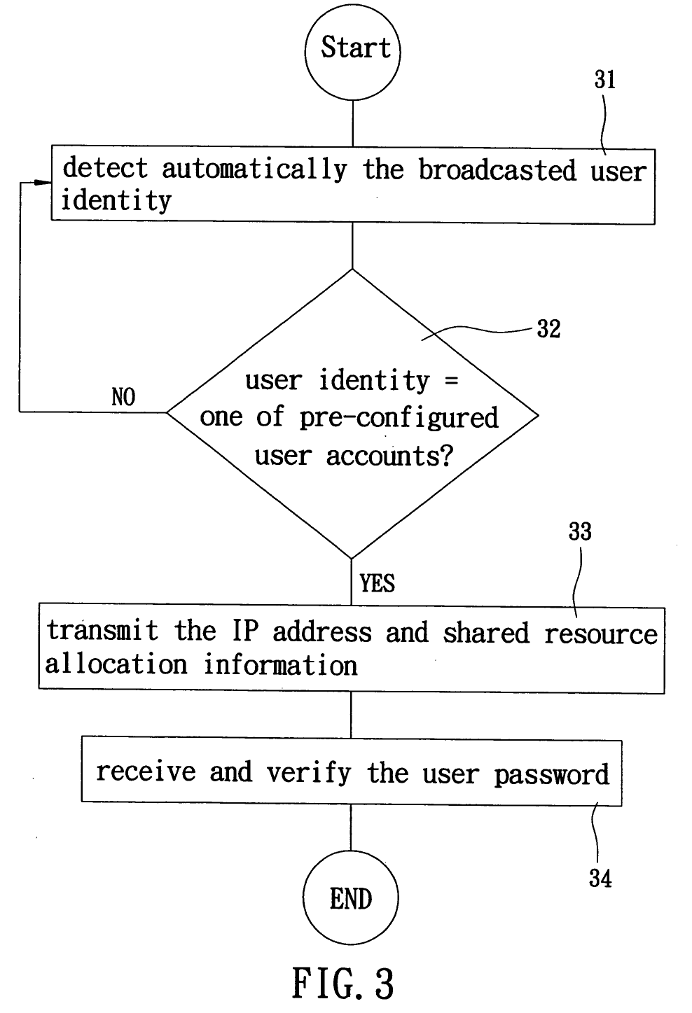

In this embodiment, the server 11 of the system 100 according to this invention is installed with proprietary daemon software 112 so as to enable it to interact with the client 12 for executing steps associated with the method of the first preferred embodiment. The steps performed by the server 11, as illustrated in FIG. 3, are as follows:

In step 31, upon booting up, the server 11 detects automatically the user identity of the client 12 broadcasted through the local area network 13.

In step 32, when the user identity of the client 12 detected in step 31 corresponds to one of the user accounts configured in the server 11, the flow proceeds to step 33. Otherwise, the flow goes back to step 31.

In step 33, the server 11 transmits the IP address and the shared resource allocation information of the server 11 through the local area network 13. Thereafter, in step 34, the server 11 receives and verifies the user password of the client 12 transmitted through the local area network 13. The client 12 is then able to map the network drive 111 of the server 11 with the use of the IP address and the shared resource allocation information of the server 11 upon successful verification of the user password by the server 11.

Preferably, the server 11 is configured to limit the client 12 within a specified amount of drive space of the mapped network drive 111. Further, the client 12 automatically assigns the mapped network drive 111 a drive letter, such as E or F, for identification.

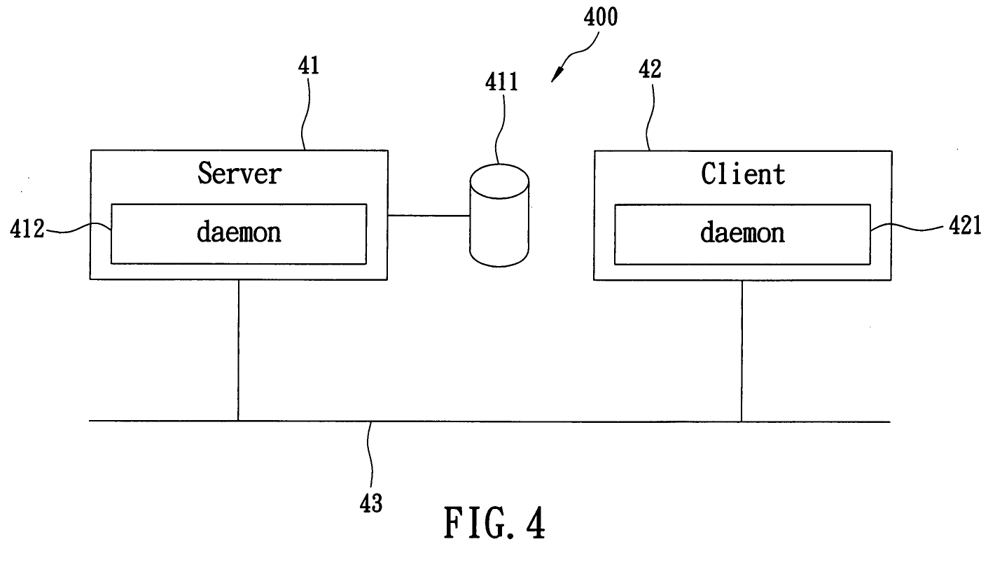

FIG. 4 illustrates a system 400 for implementing the second preferred embodiment of the method for mapping a shared resource 411 of a server 41 by a client 42 in a network 43 as initiated by the server 41.

The server 41 is configured with an internet protocol (IP) address and a plurality of predetermined user accounts.

The client 42 is configured with a user identity and a user password. In this embodiment, the client 42 is a personal computer. In an alternative embodiment, the client 42 is a notebook computer.

The network 43 is a local area network. In this embodiment, the client 42 is connected to the local area network 43 through a cable. In an alternative embodiment, the client 42 is connected to the local area network 43 wirelessly.

The shared resource 411 of the server 41 is a network drive that is to be mapped as a local drive by the client 42, in a manner that will be described hereinafter.

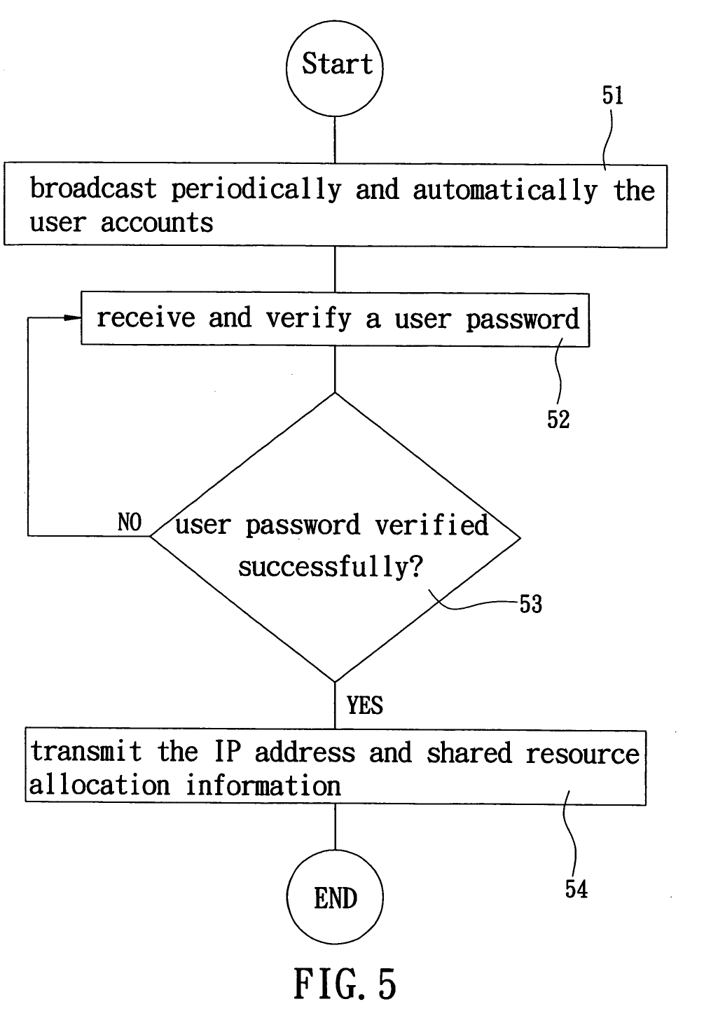

In this embodiment, the server 41 of the system 400 according to this invention is installed with proprietary daemon software 412 so as to enable it to interact with the client 42 for executing steps associated with the method of the second preferred embodiment. The steps performed by the server 41, as illustrated in FIG. 5, are as follows:

In step 51, upon booting up, the server 41 broadcasts periodically and automatically the user accounts configured therein through the local area network 43. Thereafter, in step 52, the server 41 receives and verifies the user password of the client 42 transmitted through the local area network 43.

In step 53, if the server 41 successfully verifies the user password, the flow proceeds to step 54. Otherwise, the flow goes back to step 52.

In step 54, the server 41 transmits the IP address and shared resource allocation information of the server 41 through the local area network 43. The client 42 is then able to map the network drive 411 of the server 41 with the use of the IP address and the shared resource allocation information of the server 41.

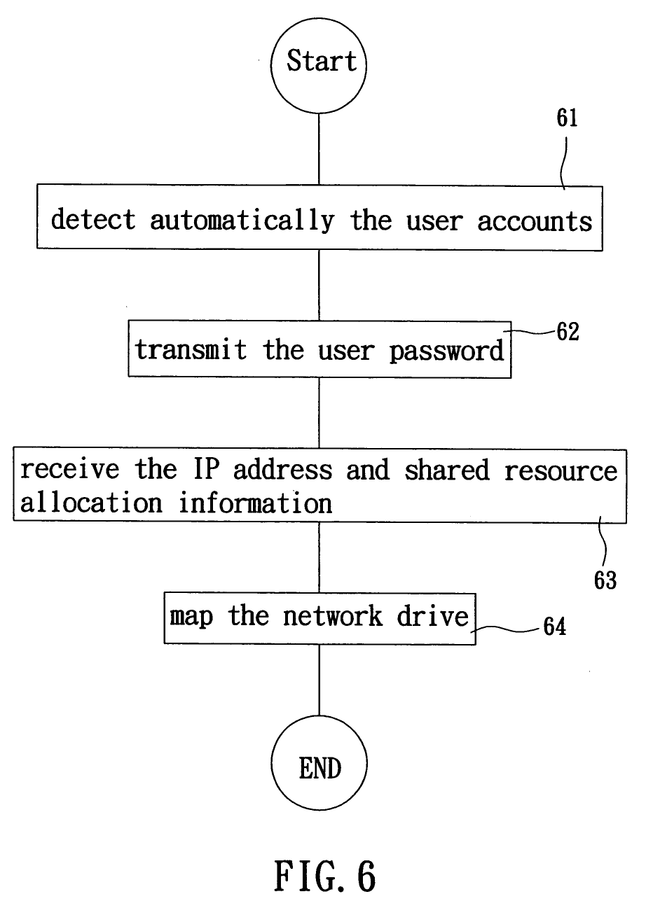

In this embodiment, the client 42 of the system 400 according to this invention is installed with proprietary daemon software 421 so as to enable it to interact with the server 41 for executing steps associated with the method of the second preferred embodiment. The steps performed by the client 42, as illustrated in FIG. 6, are as follows:

In step 61, upon booting up, the client 42 detects automatically the user accounts configured in the server 41 and broadcasted through the local area network 43.

In step 62, the client 42 transmits the user password thereof to the server 41 through the local area network 43 for verification when the user identity of the client 42 corresponds to one of the user accounts of the server 41 detected in step 61. Thereafter, in step 63, the client 42 receives the IP address and the shared resource allocation information of the server 41 through the local area network 43.

In step 64, in response to the IP address and the shared resource allocation information of the server 41 received in step 63, the client 42 maps the network drive 411 of the server 41 with the use of the IP address and the shared resource allocation information of the server 41.

Like the previous embodiment, the server 41 may be configured to limit the client 42 within a specified amount of drive space of the mapped network drive 411. Further, the client 42 automatically assigns the mapped network drive 411 with a drive letter, such as E or F, for identification.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for mapping a shared resource of a server by a client in a network, the client being configured with a user identity and a user password, the server being configured with an internet protocol (IP) address and a plurality of predetermined user accounts, said method comprising the steps of:
(A) enabling the client to broadcast automatically the user identity thereof through the network;
(B) enabling the client to receive the IP address and shared resource allocation information of the server transmitted through the network;
(C) in response to the IP address and the shared resource allocation information of the server received in step (B), enabling the client to transmit the user password thereof to the server through the network for verification; and
(D) enabling the client to map the shared resource of the server with the use of the IP address and the shared resource allocation information of the server upon successful verification of the user password by the server.

2. The method as claimed in claim 1, wherein the shared resource is a network drive.

3. A method for mapping a shared resource of a server by a client in a network, the client being configured with a user identity and a user password, the server being configured with an IP address and a plurality of predetermined user accounts, said method comprising the steps of:
(A) enabling the server to detect automatically the user identity of the client broadcasted through the network;
(B) enabling the server to transmit the IP address and shared resource allocation information of the server through the network when the user identity of the client detected in step (A) corresponds to one of the user accounts configured in the server; and
C) enabling the server to receive and verify the user password of the client transmitted through the network after step (B);
whereby the client is able to map the shared resource of the server with the use of the IP address and the shared resource allocation information of the server upon successful verification of the user password by the server.

4. The method as claimed in claim 3, wherein the shared resource is a network drive.

5. A method for mapping a shared resource of a server by a client in a network, the client being configured with a user identity and a user password, the server being configured with an IP address and a plurality of predetermined user accounts, said method comprising the steps of:
(A) enabling the server to broadcast periodically and automatically the user accounts configured therein through the network;
(B) enabling the server to receive and verify the user password of the client transmitted through the network; and
(C) enabling the server to transmit the IP address and shared resource allocation information of the server through the network upon successful verification of the password;
whereby the client is able to map the shared resource of the server with the use of the IP address and the shared resource allocation information of the server.

6. The method as claimed in claim 5, wherein the shared resource is a network drive.

7. A method for mapping a shared resource of a server by a client in a network, the client being configured with a user identity and a user password, the server being configured with an IP address and a plurality of predetermined user accounts, said method comprising the steps of:
(A) enabling the client to detect automatically the user accounts configured in the server and broadcasted through the network;
(B) enabling the client to transmit the user password thereof to the server through the network for verification when a user identity of the client corresponds to one of the user accounts of the server detected in step (A);
(C) enabling the client to receive the IP address and shared resource allocation information of the server through the network after step (B); and
(D) in response to the IP address and the shared resource allocation information of the server received in step (C), enabling the client to map the shared resource of the server with the use of the IP address and the shared resource allocation information of the server.

8. The method as claimed in claim 7, wherein the shared resource is a network drive.
